(19) United States
(12) Patent Application Publication
(10) Pub. No.: US 2005/0124180 A1
(43) Pub. Date: Jun. 9, 2005

(54) Removable card guidance block

(76) Inventors: Lambert Simonovich, Stittsville (CA); Joseph J. Lommen, Nepean (CA); Sebastien Nadeau, Gatineau (CA); Michael A. Wilson, Kemptville (CA); David A. McQuinn, Ottawa (CA); Paul A. Van Leeuwen, Ottawa (CA); Michael Miron, Kanata (CA); Anthony Mayenburg, Carp (CA)

Correspondence Address: ALAN M WEISBERG;CHRISTOPHER & WEISBERG, 200 EAST LAS OLAS BOULEVARD, SUITE 2040, FORT LAUDERDALE, FL, 33301, US

(21) Appl. No.: 10/732,623

(22) Filed: Dec. 9, 2003

(51) Int. Cl. H01R 12/00

(52) U.S. Cl. 439/64

(57) ABSTRACT

A guidance block includes a base and a pair of opposing sides. A first set of opposing sides are attached to a top side of the base and provide a first separation configured to accept a first circuit card. A second set of opposing sides are attached to a bottom side of the base and provide a second separation configured to accept a second circuit card.

### BACKGROUND

A backplane or midplane (hereafter called backplane) is an electronic circuit board that may include circuits and sockets into which other circuit boards or cards are plugged. For instance, in a computer the backplane (sometimes referred to as a motherboard) is a circuit board that includes sockets (also referred to as expansion slots) for cards. The cards (also referred to as expansion cards, boards, adapters and so forth) include circuits that provide a functional capability to the computer. The card is typically made of a rigid material and is plugged into one of the computer's expansion slots in the backplane. Cards have a variety of sizes to match corresponding socket dimensions. A card can be of full height, half height, or some other height. For example, two half-height cards would fit into one full height card slot.

### SUMMARY

In one aspect, the invention features a guidance block that includes a base. The guidance block also includes a first set of opposing sides attached to a top side of the base, the first set of opposing sides provide a first separation configured to accept a first circuit board. The guidance block also includes a second set of opposing sides attached to a bottom side of the base, the second set of opposing sides provide a second separation configured to accept a second circuit board.

Embodiments may include one or more of the following. The first set of opposing sides can accept the bottom edge of a first circuit pack and the second set of opposing sides can accept the top edge of a second circuit pack. The sides can accept multiple thicknesses of circuit packs.

The guidance block can also include a spring member. The spring member can provide alignment of a primary side of the circuit pack. The spring member and the guidance block can be comprised of an electrically conductive material.

The base can include apertures to allow the guidance block to be removably attached to a backplane or midplane. The guidance block can include a aperture in the base and a fastener. The fastener can be positioned in the aperture to attach the base to a backplane or midplane. The guidance block can also include a retaining pin, the retaining pin can prevent the complete removal of the fastener from the guidance block.

In another aspect, the invention features a guide pin retainer block and a guidance block. The guide pin retainer block includes an aperture configured to accept a fastener. The guidance block includes a base and a first set of opposing sides attached to a top side of the base, with the first set of opposing sides providing a first separation configured to accept a first circuit board. The guidance block also includes a second set of opposing sides attached to a bottom side of the base with the second set of opposing sides providing a second separation configured to accept a second circuit board.

Embodiments can include one or more of the following. The guide pin retainer block can include apertures to allow the guide pin retainer block to be removably attached to a backplane or midplane. The guide pin retainer block can include a guide pin and the guidance block can include a aperture configured to accept the guide pin and align the guidance block to the guide pin retainer block. The aperture can be conical shaped. Alternately, the guidance block includes a guide pin and the guide pin retainer block includes an aperture configured to accept the guide pin and align the guidance block to the guide pin retainer block. The aperture can be a conical shaped aperture. The guidance block can include a fastener such that the guidance block can be attached to the retainer block by inserting the fastener in the aperture configured to accept the fastener.

In another aspect, the invention features a guidance system comprising a backplane including a guidance block. The guidance block includes a base and a first set of opposing sides attached to a top side of the base, with the first set of opposing sides providing a first separation configured to accept a first circuit board. The guidance block also includes a second set of opposing sides attached to a bottom side of the base, with the second set of opposing sides providing a second separation configured to accept a second circuit board.

Embodiments may include one or more of the following. The first set of opposing-sides can accept the bottom edge of a first circuit pack and the second set of opposing sides can accept the top edge of a second circuit pack. The guidance block can include a spring member that provides alignment of a primary side of the circuit pack. The spring member and the guidance block can be comprised of an electrically conductive material. The guidance block can be grounded and the electrically conductive material can provide an electrostatic discharge (ESD) path.

In one aspect, the removable card guidance block provides the advantage of allowing a single full height card slot to be configured to accept cards of alternate heights. For example, placing one removable card guidance block in the middle of a full height slot allows two half-height cards to occupy a full height slot.

In another aspect, the removable card guidance block includes a spring to bias a card to the primary side of the removable card guidance block. This allows a user to insert a board into the device without regard for thickness of the board. The spring member aligns the connectors on the card with the connectors in the slot.

In another aspect, the removable card guidance block extends to the same extent as the card. This allows a user to insert and/or remove the removable card guidance block while cards remain active in adjacent slots.

The removable card guidance block also provides full guidance of the card from the card entry to the shelf to card termination. The removable card guidance block also permits for keying and faceplate side movement control.

The removable card guidance block provides the alignment for the top edge of a lower card, and the bottom edge of a higher card as the cards are cascaded within a single slot of a shelf. When removed, a full height card can be plugged into the same space as the cascade of smaller cards.

An integrated guide pin receptacle and a captivated extension fastener aligns and fastens the removable card guidance block to a guide pin retainer block that is permanently or semi permanently attached to the backplane.

An EMI gasket and integrated threaded female fasteners attached to face of the removable card guidance block allows for the continuous EMI shield and lockdown of cascaded faceplates.

### DESCRIPTION OF DRAWINGS

FIG. 1 depicts a backplane and a removable card guidance block that divides a full height slot to accept two half-height cards.

FIG. 2 is a diagram of the spring side of the removable card guidance block.

FIG. 3 is a diagram of the primary side of the removable card guidance block.

FIG. 4 is a diagram of the spring connection region of the removable card guidance block.

FIG. 5 is a composite view of removable card guidance block.

### DESCRIPTION

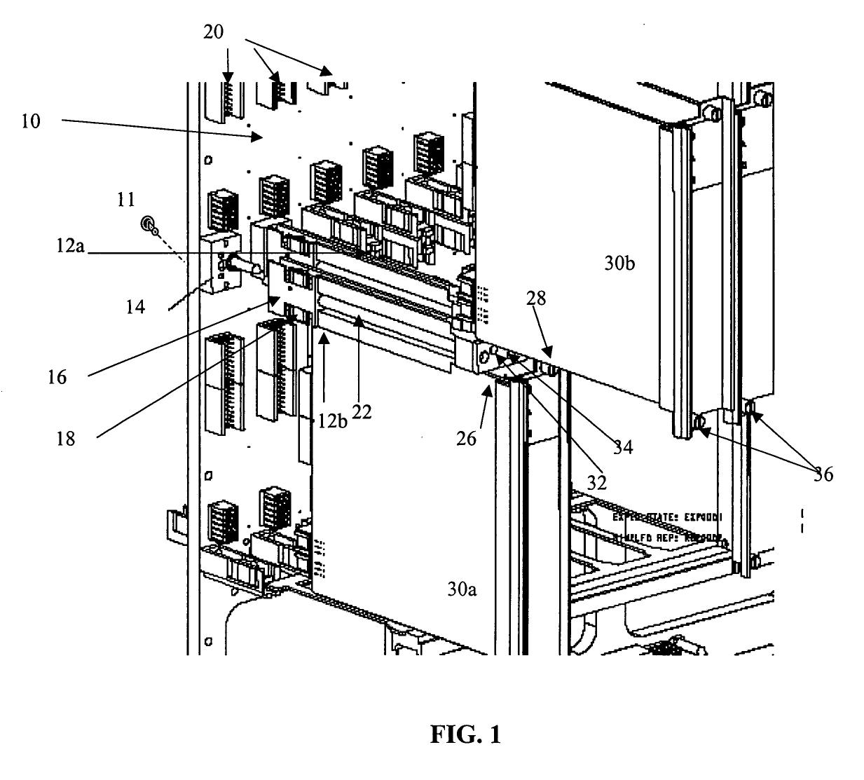

Referring to FIG. 1, a backplane 10 includes multiple slots 20. A user aligns and plugs a card 30 into one of the slots 20. Each slot fits a particular card thickness (typical card thicknesses range from 0.05 inches to 0.2 inches). In some situations, it can be advantageous to insert two half-height cards into one full height slot. For example, some applications do not require the board space of a full height card, two half-height cards can be used. By limiting the space necessary for such cards, a user can attach a greater number of cards (and greater amount of functionality) to the slots present in the backplane. The option for smaller cards also permits lower granularity per application. In order to accommodate two half-height cards 30a and 30b in a full height card slot 20, a removable card guidance block 16 attaches to the backplane 10 in the middle of the full height card slot and divides the slot into two half-height slots. The removable card guidance block 16 provides alignment of two half-height cards 30a and 30b to the slot 20. The removable card guidance block 16 includes a top slot 12a and a bottom slot 12b, each slot 12 accepts the edge of a card 30. For example, a bottom slot 12b guides the topside 26 of a first card 30a while a top slot 12a guides the bottom edge 28 of a second card 30b. Fasteners 36 screw into apertures 32 and 34 to secure cards 30a and 30b to the removable card guidance block 16.

Removable card guidance block 16 removably attaches to the backplane using a guide pin retainer block 14. Retainer block 14 attaches to the backplane using fasteners or permanently attaches to the backplane for example by bonding or soldering. The guide pin retainer block 14 does not interfere with the use of the slot for a full height card. The placement of the guide pin retainer block 14 determines the number of slots the full height slot is divided into when a removable card guidance block 16 is attached to the guide pin retainer block 14. For example, placing a single guide pin retainer block 14 in the middle of a slot 20 provides the option to divide the slot into two half-height slots. The guide pin retainer block 14 includes a threaded hole into which a fastener 11 fits to attach the guide pin retainer block to the backplane 10. Fastener 22 secures removable card guidance block 16 to guide pin retainer block 14 and allows a user to insert and remove the removable card guidance block 16 based on the current system needs.

In this example, the removable card guidance block 16 is approximately the same length as card 30. The length of the removable card guidance block 16 allows a user to attach and remove the removable card guidance block 16 while cards occupy adjacent slots. Since the fastener 22 extends past the other boards and the removable card guidance block is non-conductive (e.g., plastic), it is not necessary to insert a tool (e.g., a screwdriver) between the cards to tighten the fastener 22. This allows other cards to remain in use while a single slot 20 configured to accept a full height card is re-configured to accept two half height cards or vice versa. While, in this example the removable card guidance block 16 is approximately the same length as card 30 the removable card guidance block 16 can be any length. If the removable card guidance block is much shorter than the card 30, special tools or the removal of adjacent cards may be necessary to attach the removable card guidance block 16 to the backplane.

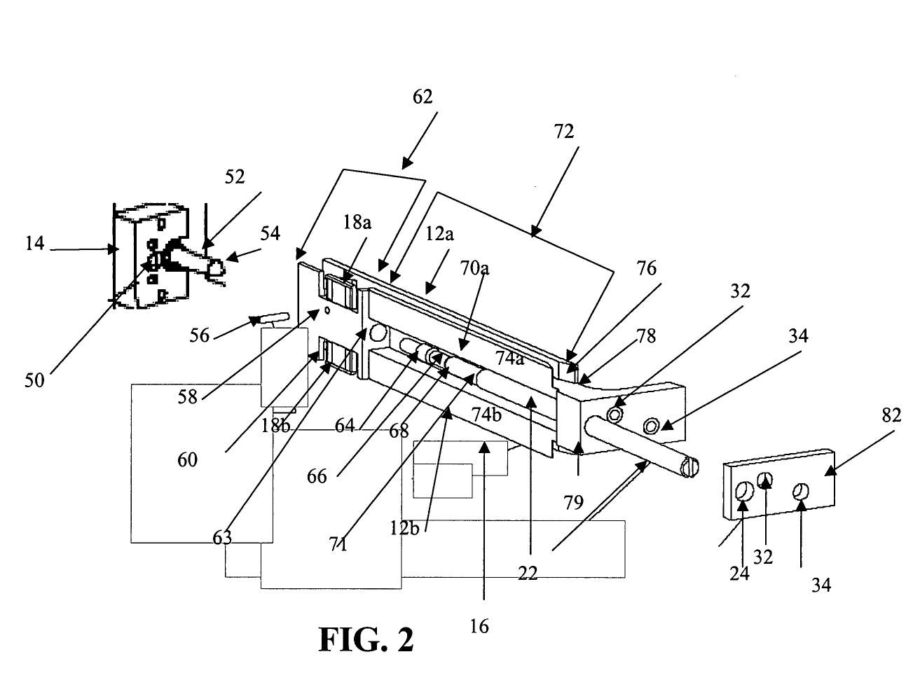

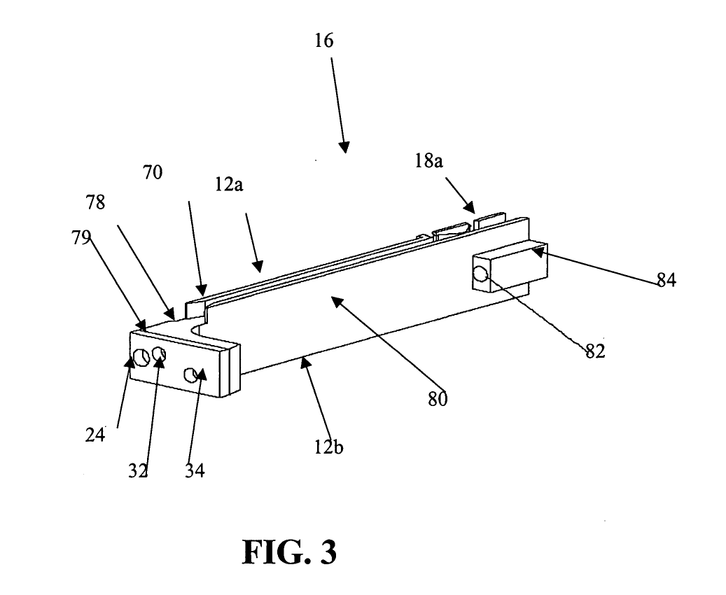

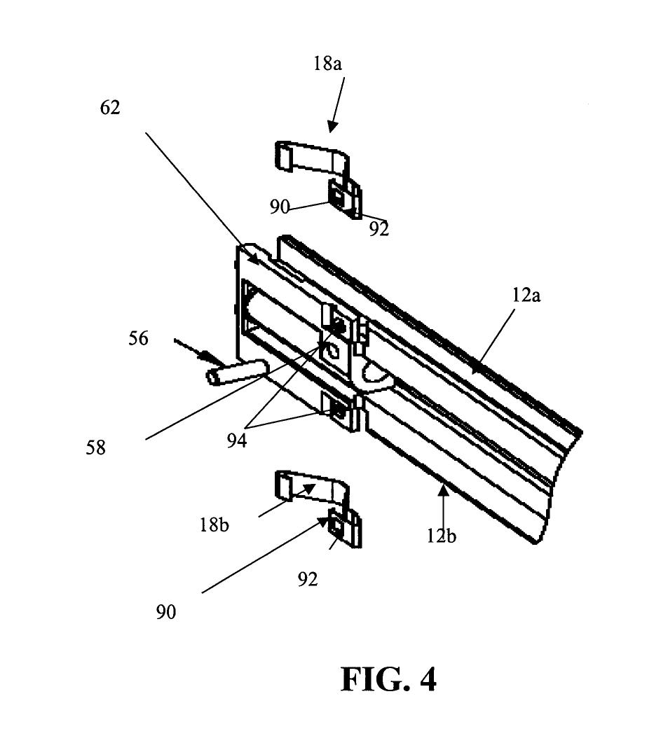

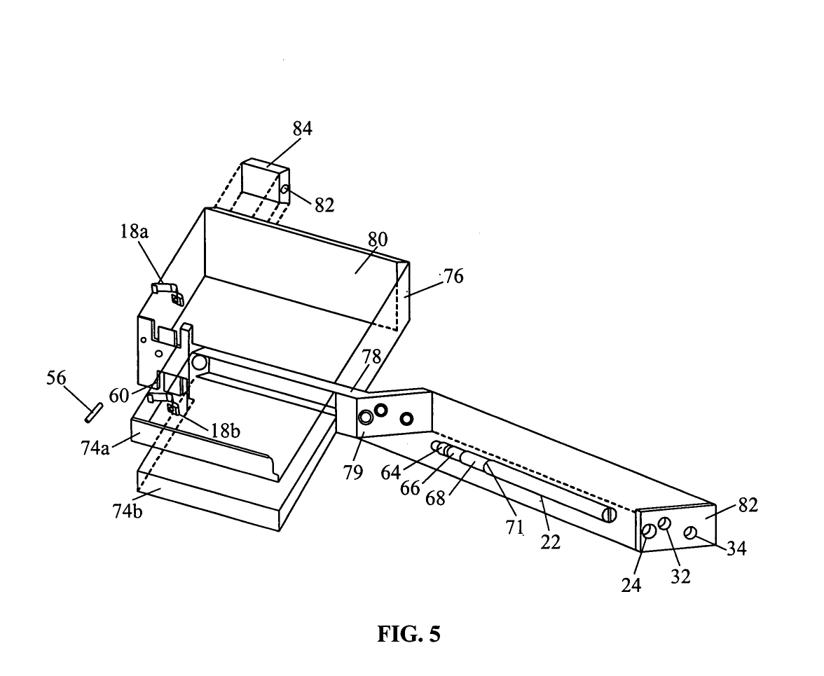

Referring to FIGS. 2-5, the removable card guidance block 16 has a spring side 60 (FIG. 2), a primary side 80 (FIG. 3), and a spring region 62 (FIG. 4). FIG. 5 shows a composite view of the removable card guidance block 16. The spring side 60 (FIG. 2) and primary side 80 (FIG. 3) attach to a body 78. The sides 60 and 80 extend vertically from both the top-side and the bottom side of the body 78 to provide slots 12a and 12b. Slots 12a and 12b each provide a separation between the opposing sides 60 and 80 into which a card can be inserted. When a user inserts a card into slot 12a or 12b, a spring 18a or 18b biases the primary side of the card to the primary side 80 of the removable card guidance block 16.

The body 78 extends the length of the device and forms the bottom of slot 12a and the top of slot 12b. Body 78 includes a card attachment piece 79 on an end not attached to the backplane. The card attachment piece 79 has three apertures 24, 32, and 34 for fasteners such as screws. A user inserts an extension fastener, e.g., fastener 22 through aperture 24 to fasten the removable card guidance block 16 to the backplane 10 (described in detail below). While aperture 24 is used to secure the removable card guidance block 16 to the backplane 10, apertures 32 and 34 are used to secure card 30 to the removable card guidance block 16. When a user inserts a card 30 into slot 12, the card is secured to body 78 by fasteners 36 (as seen in FIG. 1). Fasteners 36 placed through apertures 32 and 34 fasten a card 30 to the card attachment piece 79. While in this example, card is attached to the body 78 using screws as the fasteners, other attachment devices can be used.

In order to fasten the removable card guidance block 16 to the backplane 10, a user aligns the removable card guidance block 16 to the guide pin retainer block 14 and tightens fastener 22. For alignment, the guide pin retainer block 14 includes a guide pin 52. Guide pin 52 extends from the guide pin retainer block 14 and has a conical shaped end 54. The conical end 54 provides easier insertion of the guide pin 52 into guide pin receptacle 84 (FIG. 3). Guide pin receptacle 84 is attached to the primary side 80 of removable card guidance block 16 and has a guide pin aperture 82. The insertion of guide pin 52 into the guide pin aperture 82 aligns fastener 22 with the aperture 50. The fastener 22 extends the entire length of the removable card guidance block 16 so that a user may attach the removable card guidance block 16 to the backplane 10 without removing cards from adjacent slots. This allows a user to change a single slot from a full height card configuration to: dual half-height card configuration while other cards in adjacent slots are in use.

In the example above, the guide pin 52 includes a conical shaped end 54. In another example, the aperture 82 could include a conical shaped region to guide the guide pin 52. In another example, the guide pin attaches to the removable card guidance block 16 and the guide pin retainer block 14 includes guide aperture configured to accept the pin.

A roll pin 56 ensures that the fastener 22 does not fall out of the removable card guidance block 16. The roll pin 56 passes through a aperture 58 in the body 78 of removable card guidance block 16. The fastener 22 includes a region of lesser diameter 66 between two regions 64 and 68 of full diameter. By positioning the roll pin 56 through the roll pin aperture 58 in a location where the fastener is of lesser diameter (i.e. region 66), the pin 56 forms an aperture of a smaller diameter than the full diameter regions of the fastener 22 (i.e. regions 64 and 68). As a user inserts the fastener 22 into removable card guidance block 16, the region of the fastener 22 with a limited diameter 66 allows the fastener to be pushed into removable card guidance block 16. However, if the roll pin 56 reaches the end of the region of lesser diameter 66 and hits the region 68 of average diameter the roll pin prevents the fastener 22 from being further inserted. In a similar manner, the roll pin 56 prevents the fastener 22 from pulling out of the removable card guidance block 16 when the roll pin 56 hits region 64.

Alternately, the force to lock or seat the removable card guidance block comes from the shoulder 71 of fastener 22 seating on surface 63 of removable card guidance block. This method provides a circumferential shoulder between the screw and removable card guidance block reducing the risk of tipping or bending the plastic.

Once the removable card guidance block 16 is secured to the backplane 10 using the fastener 22, a user inserts a card 30 into a slot 12. A primary side 80, the base 78, and the spring side 60 form slot 12 to provide a separation into which the card 30 fits. The base forms the bottom/top horizontal surface of the slot 12, while spring side 60 and primary side 80 oppose each other forming parallel vertical extensions perpendicular to base 78 defining the separation into which the card fits (i.e. defining a card guide slot 12).

Spring side 60 includes an extension card guide region 72 and a spring region 62. The extension card guide region 72 of spring side 60 includes two side extension pieces 74a and 74b forming the spring side of slots 12a and 12b respectively. The extension region 72 includes an angled outer region 76 used to guide the card into the card guide slot 12. Since the angled region 76 makes the slot wider on the outer end, (where the user inserts the card 30) it provides a lead-in feature for the user to more easily insert the card 30 into the slot 12.

A spring region 62 provides macro alignment of the card 30 to the connectors in the backplane. A spring 18 attaches to spring region 62 using a lip 92 on spring 18. Lip 92 extends around a side of spring region 62 (FIG. 4). The lip 92 includes an attachment aperture 90 that snaps into a raised tab 94 on the spring region 62. The locking of the raised tab 94 into the attachment aperture 90 secures the spring 18 to the removable card guidance block 16. Spring 18 biases the card 30 toward the primary side 80 of the removable card guidance block 16. This biasing aligns a connector on the primary side of a card 30 with a connector in the backplane 10. Since the spring 18 can be depressed in varying amounts and slot 12 is wider than the card, removable card guidance block 16 can accept cards of varying thickness. Thus, if the cards are not thicker than the card guide slot 12 in the removable card guidance block 16, the removable card guidance block 16 can be used with a backplane without concern for the card thickness the backplane was configured to accept.

The spring 18 can be made of an electrically conductive material, or plastic provided it acts as a spring, moves the card, and returns to its original position after deflection. For example, the spring 18 can be made of beryllium copper stainless steel or spring steel. When the spring 18 is composed of an electrically conductive material, the guidance block 16 is composed of an electrically conductive material, and the block is grounded, the electrically conductive material provides an electrostatic discharge path from the card 30 to backplane 10. The exact shape and attachment of spring 18 can vary. For example, the spring 18 can be adhesively bonded or affixed via fasteners to spring region 62.

An electro-magnetic interference (EMI) gasket 82 attaches to the face 79 of removable card guidance block 16 and provides a continuous EMI shield of cascaded faceplates (FIG. 2). EMI gasket 82 has apertures to allow screw down of the cards at the faceplate to threaded female fasteners that are press fitted in the removable card guidance block 16. The EMI gasket can be attached to the surface using adhesive.

In one example, the spring side 60, primary side 80 and body 78 are molded from plastic producing a unitary piece having the features discussed above. Base 78 and sides 60 and 80 could instead be composed of multiple parts bonded together to form the desired structure. In another example, the base 78 and sides could be composed of metal or another firm material.

While in the example described above, each removable card guidance block 16 individually attaches to a backplane 10, multiple removable card guidance blocks 16 can be grouped to form a larger unit. For example, a backplane might include eight card slots. Thus, a grouping of eight removable card guidance blocks 16 provides splitting of each full height slot into two half-height slots.

While in the example above a single removable card guidance block 16 is used to divide a full height card slot into two half-height card slots, the removable card guidance blocks 16 could be used to divide the full height slot into a variety of heights allowed by the backplane. For example, two removable card guidance blocks 16 could be used to divide a full height slot into three ⅓-height slots or three removable card guidance blocks 16 could be used to divide a full height slot into four quarter-height slots.

A number of embodiments of the invention have been described. Nevertheless, it will be understood that various modifications may be made without departing from the spirit and scope of the invention. Accordingly, other embodiments are within the scope of the following claims.

1. A guidance block comprising:
a base;
a first set of opposing sides attached to a top side of the base, the first set of opposing sides providing a first separation configured to accept a first circuit card; and
a second set of opposing sides attached to a bottom side of the base, the second set of opposing sides providing a second separation configured to accept a second circuit card.

2. The guidance block of claim 1 wherein the first set of opposing sides accepts the bottom edge of a first circuit card and the second set of opposing sides accepts the top edge of a second circuit card.

3. The guidance block of claim 1 further comprising a spring member.

4. The guidance block of claim 3 wherein the spring member provides alignment of a primary side of the circuit card.

5. The guidance block of claim 3 wherein the spring member and the guidance block are comprised of an electrically conductive material.

6. The guidance block of claim 3 wherein the separation can accept multiple thicknesses of circuit card.

7. The guidance block of claim 1 wherein the base includes has an aperture to allow the guidance block to be removably attached to a backplane.

8. The guidance block of claim 1 further comprising an aperture in the base, and
a fastener, the fastener positioned in the aperture to attach the base to a backplane or midplane.

9. The guidance block of claim 8 further comprising a retaining pin, the retaining pin configured to prevent the complete removal of the fastener from the guidance block.

10. A card guidance system comprising:
a guide pin retainer block, the guide pin retainer block including an aperture configured to accept a fastener; and
a guidance block having
a base;
a first set of opposing sides attached to a top side of the base, the first set of opposing sides providing a first separation configured to accept a first circuit card; and
a second set of opposing sides attached to a bottom side of the base, the second set of opposing sides providing a second separation configured to accept a second circuit card.

11. The card guidance system of claim 10 wherein the guide pin retainer block includes apertures to allow the guide pin retainer block to be removably attached to a backplane or midplane.

12. The card guidance system of claim 10 wherein the guide pin retainer block includes a guide pin and the guidance block includes an aperture configured to accept the guide pin and align the guidance block to the guide pin retainer block.

13. The card guidance system of claim 10 wherein the guidance block includes a guide pin and the guide pin retainer block includes an aperture configured to accept the guide pin and align the guidance block to the guide pin retainer block.

14. The card guidance block of claim 10 wherein the guidance block includes a fastener such that the guidance block can be attached to the retainer block by inserting the fastener in the aperture configured to accept the fastener.

15. A card guidance system comprising:
a backplane including a guidance block, the guidance block including
a base;
a first set of opposing sides attached to a top side of the base, the first set of opposing sides providing a first separation configured to accept a first circuit card; and
a second set of opposing sides attached to a bottom side of the base, the second set of opposing sides providing a second separation configured to accept a second circuit card.

16. The card guidance system of claim 15 wherein the first set of opposing sides accepts the bottom edge of a first circuit card and the second set of opposing sides accepts the top edge of a second circuit card.

17. The card guidance system of claim 15 wherein the guidance block further comprises a spring member.

18. The card guidance system of claim 17 wherein the spring member provides alignment of a primary side of the circuit card.

19. The card guidance system of claim 17 wherein the spring member and the guidance block are comprised of an electrically conductive material.

20. The card guidance system of claim 19 wherein the guidance block is grounded and the electrically conductive material provides an electrostatic discharge (ESD) path.
